(19) United States
(12) Patent Application Publication
(10) Pub. No.: US 2016/0349215 A1
(43) Pub. Date: Dec. 1, 2016

(54) NON-DESTRUCTIVE EVALUATION OF ADDITIVE MANUFACTURING COMPONENTS USING AN EDDY CURRENT ARRAY SYSTEM AND METHOD

(71) Applicant: EDISON WELDING INSTITUTE, INC., Columbus, OH (US)

(72) Inventor: Evgueni I. TODOROV, Dublin, OH (US)

(21) Appl. No.: 14/971,469

(22) Filed: Dec. 16, 2015

Related U.S. Application Data
(60) Provisional application No. 62/096,300, filed on Dec. 23, 2014.

(51) Int. Cl. G01N 27/90; B33Y 70/00; B29C 67/00; B33Y 50/00

(52) U.S. Cl. CPC G01N 27/9013; B33Y 50/00; B33Y 70/00; B29C 67/0077; B29C 67/0088

(57) ABSTRACT

A system for non-destructively evaluating components fabricated by additive manufacturing, comprising a sensor array that includes a plurality of individual elements arranged in a predetermined pattern for allowing uniform coverage of an area of an electrically conductive component to be evaluated, wherein each element in the plurality of elements further includes at least one coil that acts as an exciter coil for generating an alternating electromagnetic field when activated or a receiver coil for measuring a change in impedance of the at least one coil or both an exciter coil and receiver coil, wherein the alternating electromagnetic field generates eddy currents in the component to be evaluated, and wherein the individual elements in the sensor array are excited in a predetermined sequence during a single pass of the array over the area to be evaluated; and an XY-scanner arm adapted to receive the sensor array, wherein the XY-scanner arm is operative to generate a C-scan of the area being evaluated during the single pass.

### CROSS-REFERENCE TO RELATED APPLICATIONS

This patent application claims the benefit of U.S. Provisional Patent Application Serial No. 62/096,300 filed on Dec. 23, 2014 and entitled “Non-Destructive Evaluation of Additive Manufacturing Components Using Eddy Current Array System and Method”, the disclosure of which is hereby incorporated by reference herein in its entirety and made part of the present U.S. utility patent application for all purposes.

### BACKGROUND OF THE INVENTION

The present invention relates in general to non-destructive evaluation (NDE) techniques for use in manufacturing and more specifically to a non-destructive evaluation of components made by additive manufacturing processes using an array eddy current system and method.

Additive manufacturing refers to a process by which digital three-dimension design data is used to build up a component in layers by depositing material. Instead of milling a component from solid block, additive manufacturing builds up components layer by layer using materials which are available in fine powder form. A range of different metals, plastics and composite materials may be used for this purpose. The strengths of additive manufacturing often lie in those areas where conventional manufacturing has reached its limitations. Additive manufacturing allows for the fabrication of highly complex structures which can still be extremely light and stable. It provides a high degree of design freedom, the optimization and integration of functional features, the manufacture of small batch sizes at reasonable unit costs and a high degree of product customization even in serial production. An additive manufacturing system typically starts by applying a thin layer of the powdered material to the building platform. A powerful laser beam then fuses the powder at exactly the points defined by the computer-generated component design data. The platform is then lowered and another layer of powder is applied. The material is again fused so as to bond with the layer below at the predefined points. Depending on the material used, components can be manufactured using stereolithography, laser sintering or 3D printing.

Various non-destructive evaluation techniques (e.g., visual, ultrasonics, liquid penetrant, magnetic particles, eddy current, radiography, or others as applicable) may be used as a single modality or in combination for examining critical additive manufacturing components after the fabrication thereof. However, post additive manufacturing examination may be very challenging, if even possible, for certain components having complex shapes, where the full benefits of the additive manufacturing process are realized. A possible approach to addressing this issue would be to conduct very comprehensive monitoring and examination of the additive manufacturing components during fabrication, ideally layer-by-layer. Various modalities have been proposed and used for monitoring additive manufacturing process parameters, component shape, heat transfer, and other relevant aspects and parameters. However, non-destructive evaluation techniques that will simultaneously detect small surface and subsurface, tight and volumetric discontinuities as well as large areas having irregular shapes exposed and/or hidden by powder have not been adequately demonstrated. Thus, there is an ongoing need for a fully effective system and/or method for conducting non-destructive evaluation of components created by the additive manufacturing process.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a system for non-destructively evaluating components fabricated by additive manufacturing is provided. This system includes a sensor array having a plurality of individual elements arranged in a predetermined pattern for allowing uniform coverage of an area of an electrically conductive component to be evaluated, wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil; and wherein the individual elements in the sensor array are excited in a predetermined sequence during a single pass of the array over the area to be evaluated; and an XY-scanner arm adapted to receive the sensor array, wherein the XY-scanner arm is operative to generate a C-scan of the area being evaluated during the single pass.

In accordance with another aspect of the present invention, a device for non-destructively evaluating components fabricated by additive manufacturing is provided. This device includes a sensor array having a plurality of individual elements arranged in a staggered pattern for allowing uniform coverage of an area of an electrically conductive component to be evaluated, wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil, wherein the alternating electromagnetic field generates eddy currents in the component to be evaluated, and wherein the individual elements in the sensor array are excited in a predetermined sequence during a single pass of the array over the area to be evaluated; an XY-scanner arm adapted to receive the sensor array, wherein the XY-scanner arm is operative to generate a C-scan of the area being evaluated during the single pass; and a processor for receiving and characterizing data gathered by the sensor array.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1A depicts the equipment arrangement of an array eddy current system for additive manufacturing component examination in accordance with an exemplary embodiment of the present invention; and FIG. 1B depicts an array eddy current sensor in accordance with an exemplary embodiment of the present invention;

FIG. 2 is a graphic illustration of a real-time monitoring and non-destructive evaluation system for use with an additive manufacturing system that includes an array eddy current sensor;

FIG. 3 depicts Inconel 625 experimental specimens having additive manufacturing and electrical discharge machining flaws;

FIGS. 4A, 4B, and 4C each depict the imaging and detection of flaws on a logo specimen using the array eddy current system of FIG. 1A; and

FIGS. 5A, 5B, and 5C each depict the imaging and detection of flaws on a calibration specimen using the array eddy current system of FIG. 1A.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates in general to non-destructive evaluation (NDE) techniques for use in manufacturing and more specifically to a non-destructive evaluation of components made by additive manufacturing processes using an array eddy current system and method. This invention may be used for both process monitoring and non-destructive evaluation during and after fabrication. The subject matter included in Appendix A, attached hereto, provides additional disclosure relevant to this invention and is incorporated herein, in its entirety.

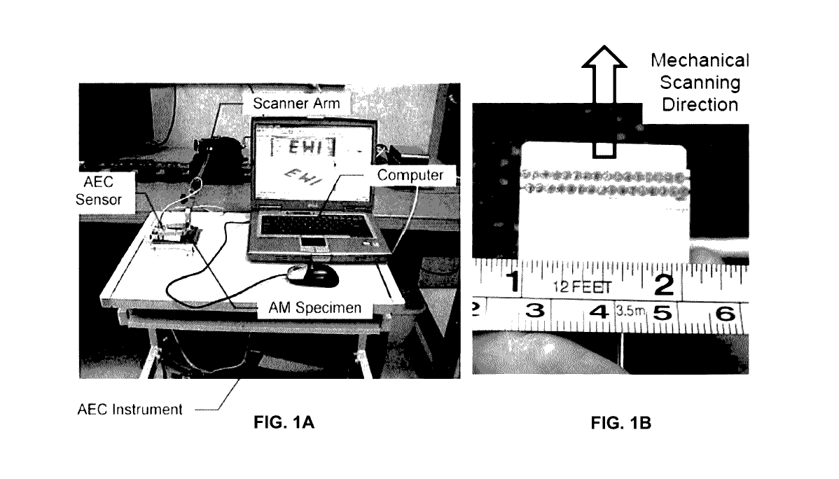

The present invention provides a nondestructive evaluation system and method for assessing the quality of additive manufacturing components. With reference generally to the Figures, an exemplary system was assembled as shown in FIG. 1A using commercially available array eddy current equipment. The array eddy current sensor was mounted on an XY-scanner arm for generating a C-scan view of an inspected area. The array eddy current sensor (see FIG. 1B) includes multiple eddy current elements (i.e., coils) arranged in a predetermined pattern (e.g., staggered) for allowing uniform coverage of the inspected area. The individual elements are excited in a predetermined sequence while the array scan covers the entire area in a single pass. When a coil is excited, an alternating magnetic field is generated that in turn induces eddy currents in the additive manufacturing component, if the component itself is electrically conductive. The eddy current density and distribution in the additive manufacturing component will depend mainly on the material electromagnetic properties (e.g., magnetic permeability and electrical conductivity), electromagnetic field strength and frequency, geometry of the additive manufacturing component, and the element or coil geometry generating the field. Changes in the eddy current electromagnetic field caused by changes in additive manufacturing material properties that affect electrical conductivity and/or magnetic permeability and the presence of discontinuities and variations of distance between the sensor and the inspected area (e.g., a surface irregularity) will be registered with the same or different elements or coils of the array eddy current sensor apparatus. This system can separate geometry and surface irregularity changes from material localized discontinuities and larger areas where material properties (e.g., stresses, phase and chemical composition and others) deviate from specifications as long as the material property variations affect electrical conductivity and or magnetic permeability.

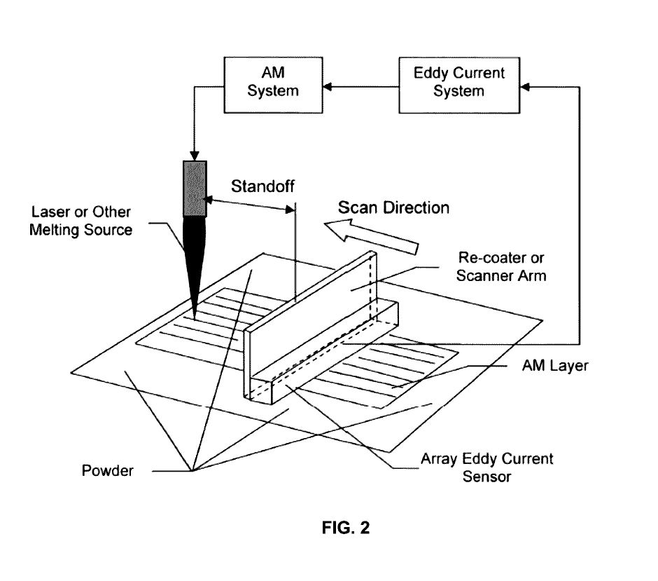

When monitoring an additive manufacturing process with the system and method of the present invention, the examination is conducted after the deposition of each layer, scanning the resultant surface at very close proximity (e.g., a distance of about 75 to 125 microns). Scanning is accomplished without physical contact for reliable interrogation of the entire layer volume for surface, subsurface discontinuities, surface shape deviations and other conditions (e.g., change of microstructure, metallurgical phase, stresses and others). For specific additive manufacturing processes such as laser-powder bed fusion (L-PBF), the array eddy current sensor may be mounted on a re-coater blade or specially designed scanner arm in the LPBF chamber (see FIG. 2). This allows for layer-by-layer examination and coverage of an entire area of interest with a minimum number of passes and precise positioning with respect to the surface of the top layer of the additive manufacturing component. The examination may be conducted by following the laser or other fusion source when a single strip is deposited or after deposition of each successive layer for examining the entire surface before the application of powder for the next layer.

The sensor will generate a signal when a critical discontinuity (e.g., crack, lack of side wall fusion, porosity), shape irregularity (e.g., lack of fusion over a large area), or defect condition (e.g., alloy composition deviation, stress) is detected. The eddy current system will then process the discontinuity or condition signal and will forward a trigger signal to the additive manufacturing system. The additive manufacturing system will then classify the eddy current trigger signal and will correct the additive manufacturing process as necessary to eliminate the eddy current trigger signal (i.e., discontinuity or condition). The location and size of the area or region indicated by eddy current will be recorded and evaluated as being acceptable or unacceptable (rejectable). If the indication is unacceptable, it will be possible to reposition the system with the array eddy current sensor, repair the indication location and reexamine.

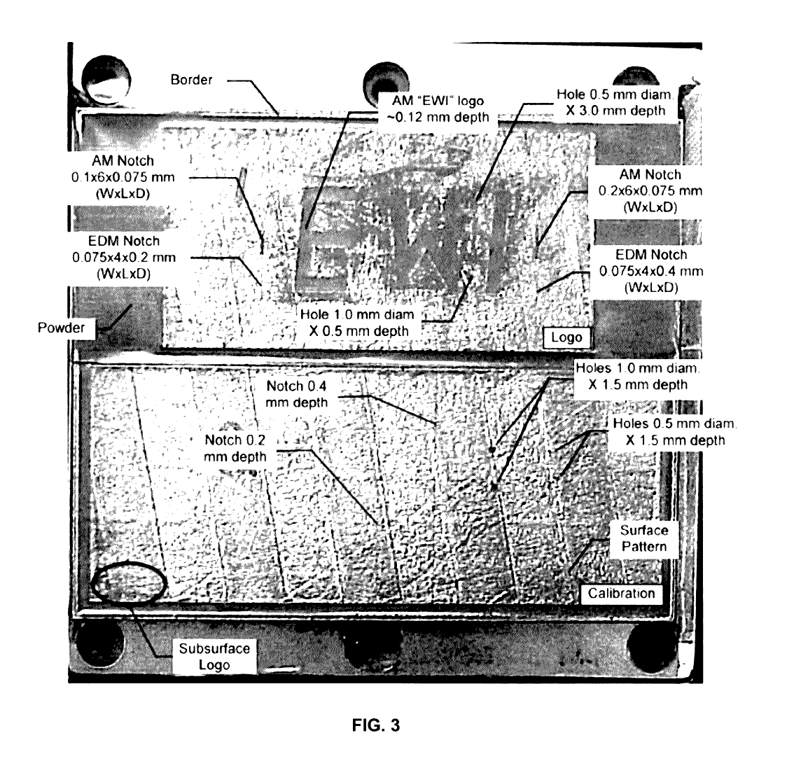

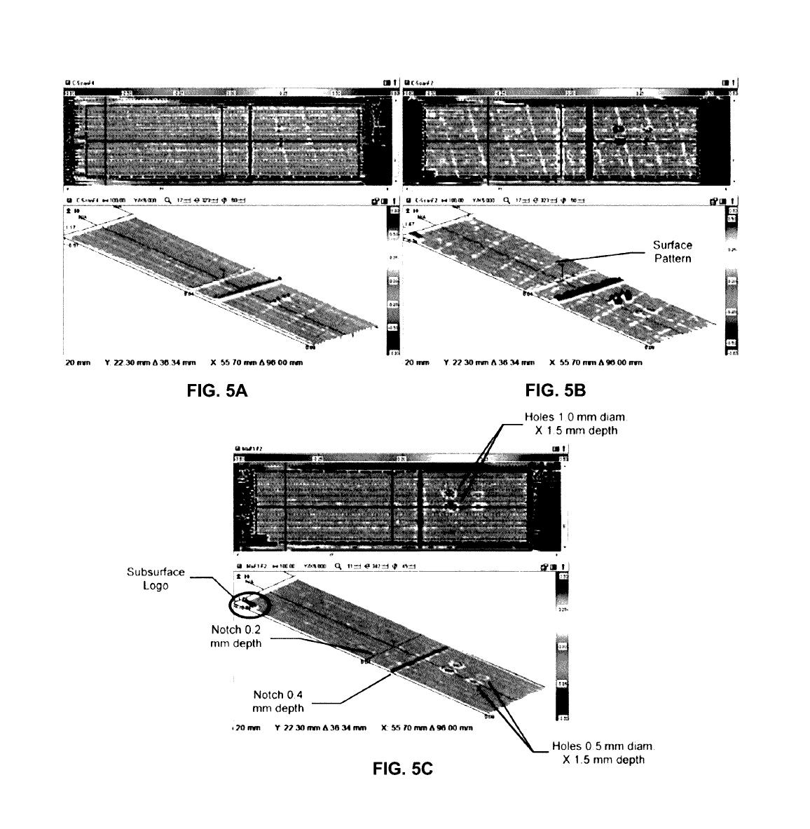

The array eddy current capabilities of this invention have been demonstrated in the imaging and detection of implanted natural (additive manufacturing) and artificial electrical discharge machining (EDM) discontinuities. With reference to FIG. 3, two metal specimens (Logo and Calibration) were additively fabricated. Additive manufacturing and EDM notches and holes representing tight discontinuities such as cracks, volumetric pores and unfused larger areas (i.e., EWI logo) were implanted with the dimensions indicated in FIG. 3. An additional subsurface EWI logo was fabricated using additive manufacturing (internal cavity) with dimensions of 4.8 mm length, 0.6 mm width, 1.7 mm height, at a depth of 2.1 mm (0.4 mm ligament) from the surface, as shown in FIG. 3 and FIGS. 5A-C. Both specimens, Logo and Calibration, were built on the same substrate surrounded by a border to form a “sandbox”. After fabrication by additive manufacturing and EDM cutting, metal powder was poured around the specimens and in the discontinuities to simulate the powder presence around the specimens and inside the lack of fusion areas during an actual fabrication process. The specimens' top surface was covered with a tape (about 75 micron in thickness) to simulate examination that does not require direct contact between the sensor and specimen surface.

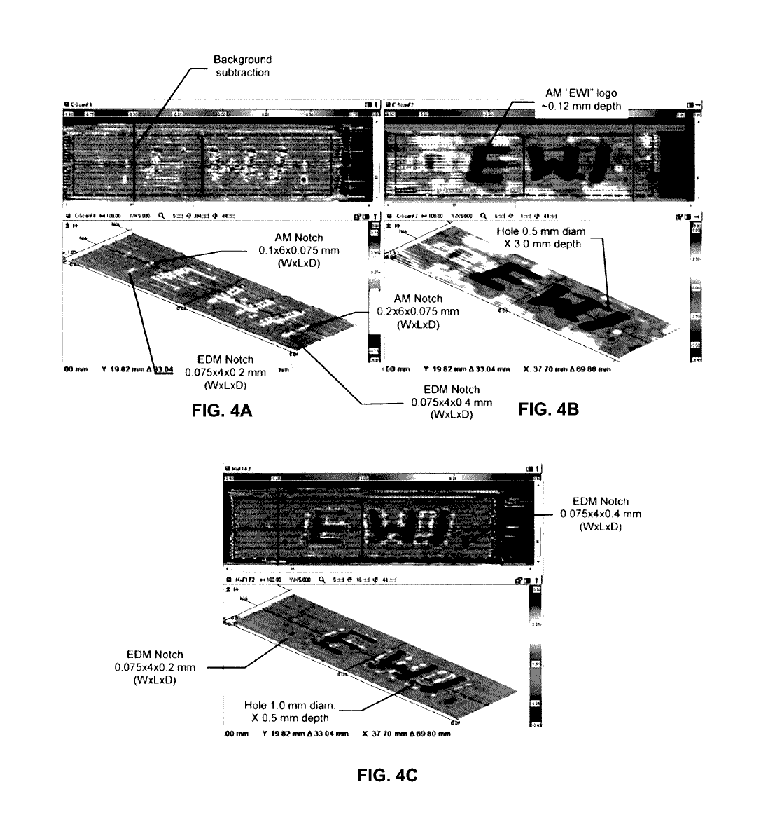

Examination data for the Logo specimen is shown in FIGS. 4A-C. Lower 1.5 MHz and higher 4 MHz frequency and mixed signals (1.5 MHz mixed with 750 kHz) are shown in FIG. 4A, FIG. 4B and FIG. 4C, respectively. The EWI logo represented larger surface irregularity caused by lack of fusion and is better detected and imaged by the horizontal signal component (sensor lift off) shown in FIG. 4B. Notches representing tight discontinuities such as cracks are better detected on vertical signal component FIG. 4A. Volumetric discontinuities such as holes simulating pores are detected on both the horizontal component FIG. 4B) and the vertical mixed (suppressed lift off) signal component (FIG. 4C). Background subtraction (i.e., the vertical line on C-scan) was used on all three plots to separate discontinuities and surface features from noise and large background signals. All additive manufacturing and EDM discontinuities and drilled holes along with the EWI logo were correctly detected and imaged. Discontinuities and features with larger dimensions were easier to detect and image.

Examination data for the Calibration specimen is shown in FIGS. 5A-C. Lower 1.5 MHz and higher 4 MHz frequency and mixed signals (1.5 MHz mixed with 750 kHz) are shown in FIG. 5A, FIG. 5B and FIG. 5C, respectively. As previously discussed, notches representing tight discontinuities such as cracks are more effectively detected on the vertical signal and vertical mixed signal component plots FIG. 5A through FIG. 5C. Volumetric discontinuities such as holes simulating pores are detected on both the vertical component (FIG. 5B) and the vertical mixed signal component (FIG. 5C). Background subtraction (i.e., the vertical line on C-scan) was used on all three plots to separate discontinuities and surface features from noise and large background signals. All EDM notches and drilled holes were correctly detected and imaged. Discontinuities with larger dimensions were easier to detect and image.

The surface deposition pattern and subsurface EWI logo (cavity) were also detectable as shown in FIGS. 5A-C. As expected, the subsurface EWI logo was detected at lower frequencies of 750 kHz and 1.5 MHz FIG. SB) and not detected at higher frequencies 3 MHz and 4 MHz (FIG. 5A) due to limited penetration at higher frequencies. However, the surface breaking discontinuities were detected at higher and lower frequencies with better resolution and sensitivity at the highest frequency of 4 MHz (FIG. 5A). This illustrates the ability of the system and method of this invention to separate surface from subsurface discontinuities. All volumetric discontinuities and logo were detected with the powder inside representing the natural condition.

Exemplary equipment for use with this invention includes: (i) eddy current instrument: MS5800 MultiScan (Olympus NDT); (ii) data acquisition software: MultiView 6.0R8 (Olympus NDT); (iii) multiplexer: AATX 306A (Olympus NDT); (iv) multiplexer cable: 41-pin, EWIX247C-004; (v) array eddy current sensor: SBBR-026-03M-032 (Olympus NDT); and (vi) flexible XY-scanner: Manual Version B, 103769-IUM-01B(ang).

This invention significantly reduces post additive manufacturing non-destructive evaluation requirements by examining the entire volume of each layer for critical surface and subsurface discontinuities and/or conditions in any orientation. This technique also allows for fast repair and subsequent examination of the additive manufacturing repair while the part is still in the additive manufacturing chamber, without the removal of powder. The present invention is potentially useful in all industries requiring fast and reliable prototyping and fabrication of critical components with minimum post-fabrication inspection requirements.

Important aspects and advantages of this invention include: (i) a sensor mounted on re-coater blade or scanner arm to provide real time inspection of additive manufacturing components layer-by-layer; (ii) the sensor can either follow the laser beam or other fusion source or conduct the examination immediately after deposition of entire layer; (iii) the separation of geometry and surface irregularity changes from material localized discontinuities and larger area material properties variations (surface geometry variations when larger than sensor effective diameter are measured as variations in distance or lift off between the sensor and surface (e.g. signal horizontal component) while changes in material properties and localized discontinuities generate different signals than lift off; (iv) the separation of surface from subsurface discontinuities and features; (v) simultaneous monitoring and nondestructive evaluation during fabrication; (vi) elimination or reduction of destructive testing and sampling; (vii) the elimination or significant reduction of post additive manufacturing non-destructive evaluation; (viii) the ability to work close to hot surfaces without physical contact following the laser or other fusion source; (ix) providing real time feedback to the additive manufacturing system to correct the process when necessary; (x) detecting longitudinal and transverse discontinuities and conditions with one pass; (xi) examining the component simultaneously for surface and subsurface discontinuities, conditions and surface irregularities with any orientation; and (xii) the presence of metal powder inside the discontinuities and surface irregularities does not affect overall performance of the technique.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

1. A system for non-destructively evaluating components fabricated by additive manufacturing, comprising:
(a) a sensor array;
(i) wherein the sensor array includes a plurality of individual elements arranged in a predetermined pattern for allowing uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field generates eddy currents in the component to be evaluated; and
(iv) wherein the individual elements in the sensor array are excited in a predetermined sequence during a single pass of the array over the area to be evaluated; and
(b) an XY-scanner arm adapted to receive the sensor array, wherein the sensor array and XY-scanner arm are operative to generate a C-scan of the area being evaluated during the single pass.

2. The system of claim 1, further comprising a processor for receiving and characterizing data gathered by the sensor array.

3. The system of claim 1, wherein the predetermined pattern of the individual elements in the sensor array is a staggered pattern.

4. The system of claim 1, wherein the sensor array is positioned at a distance of about 75-125 microns from the surface being scanned.

5. The system of claim 1, wherein the system is operative to detect cracks, lack of side wall fusion, porosity defects, shape irregularities, alloy composition deviations, and stressed areas of the component being evaluated.

6. The system of claim 1, wherein the system is adapted to laser-powder bed fusion processes.

7. A device for non-destructively evaluating components fabricated by additive manufacturing, comprising:
(a) a sensor array;
(i) wherein the sensor array includes a plurality of individual elements arranged in a staggered pattern for allowing uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field generates eddy currents in the component to be evaluated; and
(iv) wherein the individual elements in the sensor array are excited in a predetermined sequence during a single pass of the array over the area to be evaluated;
(b) an XY-scanner arm adapted to receive the sensor array, wherein the sensor array and XY-scanner arm are operative to generate a C-scan of the area being evaluated during the single pass; and
(c) a processor for receiving and characterizing data gathered by the sensor array.

8. The device of claim 7, wherein the sensor array is positioned at a distance of about 75-125 microns from the surface being scanned.

9. The device of claim 7, wherein the device is operative to detect cracks, lack of side wall fusion, porosity defects, shape irregularities, alloy composition deviations, and stressed areas of the component being evaluated.

10. The device of claim 7, wherein the device is adapted to laser-powder bed fusion processes.

11. The device of claim 7, wherein the device operates at a frequency between 1.5 MHz and 4 MHz.

12. A system for non-destructively evaluating components fabricated by additive manufacturing, comprising:
(a) a laser powder bed fusion apparatus;
(b) a sensor array;
(i) wherein the sensor array includes a plurality of individual elements arranged in a staggered pattern for allowing uniform coverage of an area of an electrically conductive component to be evaluated;
(ii) wherein each element in the plurality of elements further includes at least one coil that acts as an exciter coil for generating an alternating electromagnetic field when activated, or a receiver coil for measuring a change in impedance of the at least one coil, or as both an exciter coil and a receiver coil;
(iii) wherein the alternating electromagnetic field generates eddy currents in the component to be evaluated; and
(iv) wherein the individual elements in the sensor array are excited in a predetermined sequence during a single pass of the array over the area to be evaluated;
(c) a re-coater blade mounted in the laser powder bed fusion apparatus, wherein the re-coater blade is adapted to receive the sensor array, wherein the sensor array and the re-coater blade generate a C-scan of the area being evaluated during the single pass; and
(d) a processor for receiving and characterizing data gathered by the sensor array.

13. The system of claim 12, wherein the sensor array is positioned at a distance of about 75-125 microns from the surface being scanned.

14. The system of claim 12, wherein the system is operative to detect cracks, lack of side wall fusion, porosity defects, shape irregularities, alloy composition deviations, and stressed areas of the component being evaluated.

15. The system of claim 12, wherein the system operates at a frequency between 1.5 MHz and 4 MHz.

16. The system of claim 12, wherein the system operates at a frequency of 1.5 MHz mixed with 750 kHz.
